(19) United States
(12) Patent Application Publication
(10) Pub. No.: US 2019/0025872 A1
(43) Pub. Date: Jan. 24, 2019

(54) USB DEVICE WITH CLOCK DOMAIN CORRELATION

(71) Applicant: QUALCOMM Incorporated, San Diego, CA (US)

(72) Inventors: Ren Li, San Diego, CA (US); Peter Shah, San Diego, CA (US); Matthew Sienko, San Diego, CA (US); Hui-ya Liao Nelson, San Diego, CA (US); Stefan Rohrer, Simonswald (DE); Arash Mehrabi, San Diego, CA (US); Stefan Mueller, Freiburg (DE); Ralf Herz, Freiburg (DE); Magesh Hariharan, San Diego, CA (US); Maoxin Wei, San Diego, CA (US)

(21) Appl. No.: 15/652,516

(22) Filed: Jul. 18, 2017

(51) Int. Cl. G06F 1/12; G06F 13/42

(52) U.S. Cl. CPC G06F 1/12; G06F 2213/0042; G06F 13/4282

(57) ABSTRACT

Methods and USB devices correlating clock domains are presented. A USB device includes at least one signal line adapted to carry signals in a first clock domain. The signals are received from a USB host. A clock operates a second clock domain. A periodic packet detection circuit detects a missing periodic packet from the signals received in the first clock domain. A device controller correlates a USB operation in the second clock domain with the first clock domain based on the periodic packet detection circuit detecting the missing periodic packet. A USB device includes at least one signal line carrying UTMI or ULPI signaling. A USB controller decodes packet identification from the UTMI or ULPI signaling. A periodic packet detection circuit, separate from the USB controller, decodes packet identification from the UTMI or ULPI signaling.

### TECHNICAL FIELD

Certain aspects of the present disclosure generally relate to Universal Serial Bus (USB) devices, and, more particularly, to USB devices that correlate clock domains.

### BACKGROUND

A USB system may include a USB host and a USB device, such as a headset. The USB host (e.g., a mobile terminal, a laptop, a desktop, etc.) may be connected to the device for voice call or audio playback. Thus, the USB host may provide audio data to the USB device in various formats (e.g., MP3, HiFi audio). The USB host may sometimes be referred to as a source (e.g., of the audio data) and the USB device may sometimes be referred to as a sink (e.g., of the audio data). The USB host and the USB device may run on different clock domains. For example, the USB host may operate on a host clock (and therefore, operates on the host clock domain), and the USB device may operate on a device clock (and therefore, operates on the device clock domain). The two clock may exhibit clock drifts (in parts per million (ppm)) due to, for example, different crystals and temperature variations. Thus, there is a need for the USB device to operate on data across different clock domains.

### SUMMARY

This summary identifies features of some example aspects, and is not an exclusive or exhaustive description of the disclosed subject matter. Whether features or aspects are included in, or omitted from this Summary is not intended as indicative of relative importance of such features. Additional features and aspects are described, and will become apparent to persons skilled in the art upon reading the following detailed description and viewing the drawings that form a part thereof.

Certain aspects of the present disclosure generally relate to USB devices, and, more particularly, to USB devices that correlate clock domains. A USB device is provided. The USB device may include at least one signal line adapted to carry signals in a first clock domain, the signals being received from a USB host. A clock operates a second clock domain. A periodic packet detection circuit is adapted to detect a missing periodic packet from the signals received in the first clock domain. A device controller is adapted to correlate a USB operation in the second clock domain with the first clock domain based on the periodic packet detection circuit detecting the missing periodic packet.

A method for operating a USB device is provided. The method includes; providing signals in a first clock domain, the signals being received from a USB host; detecting a missing periodic packet from the signals received in the first clock domain; and correlating a USB operation in a second clock domain with the first clock domain based on detecting the missing periodic packet.

Another USB device is provided. The USB device includes at least one signal line adapted to carry UTMI or ULPI signaling. A USB controller adapted to decode packet identification in the UTMI or ULPI signaling. A periodic packet detection circuit, separate from the USB controller, is adapted to decode packet identification in the UTMI or ULPI signaling.

A method for operating a USB device is provided. The method includes decoding packet identification in UTMI or ULPI signaling via a first decoding path and decoding second packet identification in the UTMI or ULPI signaling via a second decoding path, the second decoding path being independent from the first decoding path.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of a USB system, in accordance with certain aspects of the present disclosure.

FIG. 2 is an asynchronous mode dataflow diagram of a USB system, in accordance with certain aspects of the present disclosure.

FIG. 3 is a diagram of a control component of a USB device, in accordance with certain aspects of the present disclosure.

FIG. 4 is a diagram of a periodic packet detection circuit of a USB device, in accordance with certain aspects of the present disclosure.

FIG. 5 is a diagram of decoding packet identification from UTMI signaling, in accordance with certain aspects of the present disclosure.

FIG. 6 is a diagram of certain operations of a device controller, in accordance with certain aspects of the present disclosure.

FIG. 7 is a diagram of certain operations of a device controller, in accordance with certain aspects of the present disclosure.

FIG. 8 is a flow diagram of certain operations of a device controller, in accordance with certain aspects of the present disclosure.

FIG. 9 is a diagram of a device controller, in accordance with certain aspects of the present disclosure.

FIG. 10 is a flow diagram of example operations of a USB device, in accordance with certain aspects of the present disclosure.

FIG. 11 is a flow diagram of example operations of a USB device, in accordance with certain aspects of the present disclosure.

### DETAILED DESCRIPTION

The word “exemplary” is used herein to mean “serving as an example, instance, or illustration.” Any aspect described herein as “exemplary” is not necessarily to be construed as preferred or advantageous over other aspects. Signal line or lines may refer to a conductor or wiring carrying various signals. Signals on the signal line or lines may refer to the underlying data represented by the signals.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

The present disclosure relates to USB operations. Within this context, the term “frame” may refer to a set time period. For example, a frame in this disclosure may refer to the frame (e.g., 1 ms for full-speed bus) and/or microframe (e.g., 125 μs for high-speed bus) specified in the USB specification, as would be recognized by persons of ordinary skills in the art.

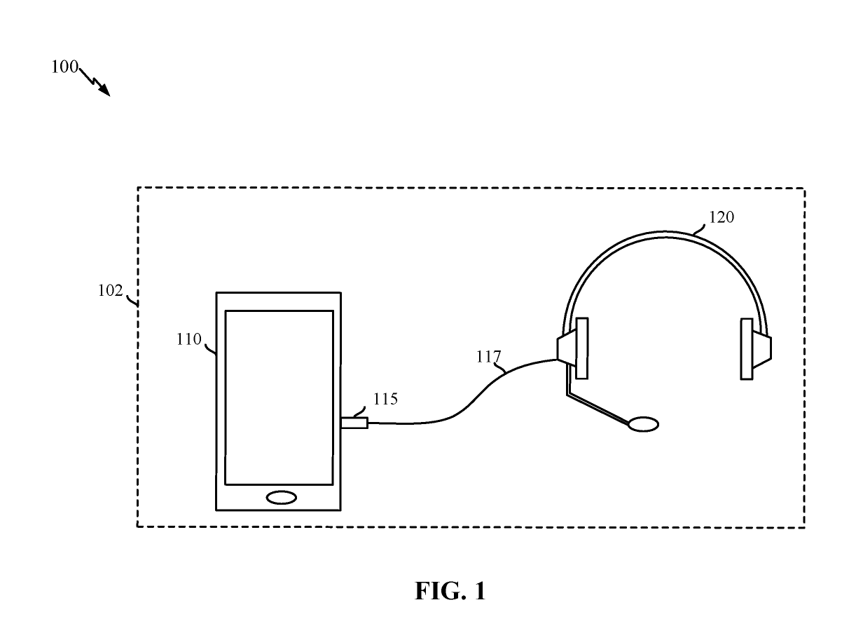

FIG. 1 is a diagram 100 of a USB system 102, in accordance with certain aspects of the present disclosure. The USB system 102 may include a USB host 110 and a USB device 120. The USB host 110 may be, for example, a mobile terminal, a desktop, a laptop, or a music source, etc., that provides data in accordance with the USB specification. The device may be, for example, a headset or any device that receives the data provided by the USB host 110 in accordance with the USB specification. The USB host 110 and the USB device 120 may be coupled or connected via a USB link 117 and a USB connector 115. Examples of the USB link 117 may include cable or a wireless USB link. In the present disclosure, audio data are presented as examples of the data provided on the USB link 117.

USB 2.0 specification provides three modes for USB host and USB device audio synchronization: the synchronous mode, the adaptive mode, and the asynchronous mode. The synchronous mode is the simplest and is of the lowest audio quality. In the synchronous mode, the device clock of the USB device may be synchronized with the USB Start-of-Frame (SOF) signaling (e.g., an SOF packet with SOF packet identification) and may accept data whenever the USB host sends the data. However, such scheme may lead to audio glitch. In the adaptive mode, the USB device synchronizes the device clock to a received host clock. The USB device may then adaptively adjust the device clock based on, for example, the data size in buffer. The host clock may be noisy, which may lead to jitter and digital distortion in the digital stream. The adaptive mode may be of acceptable audio quality for consumer-grade applications.

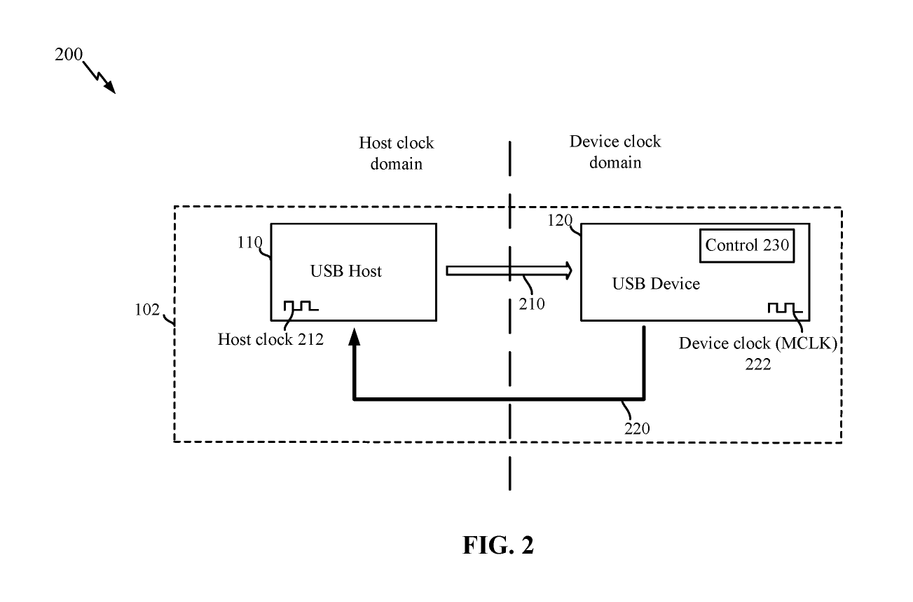

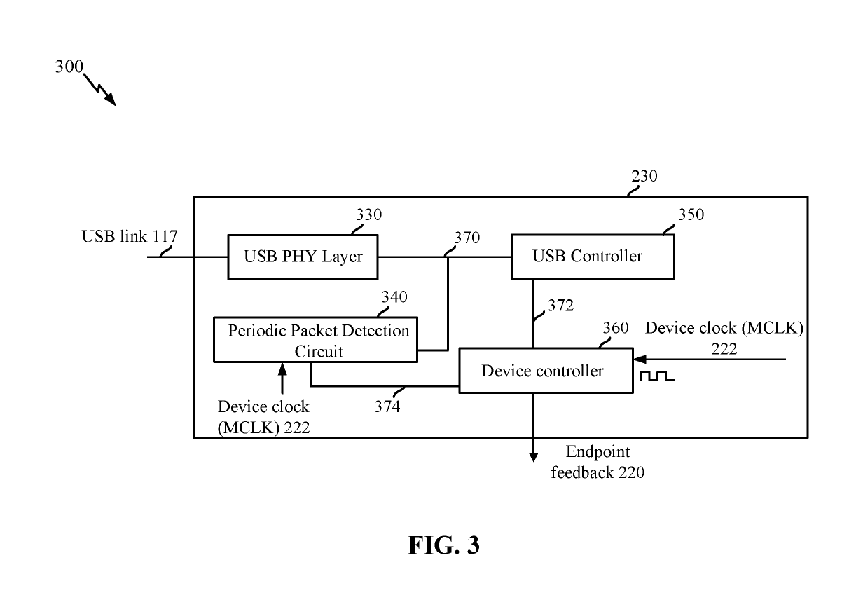

The asynchronous mode may produce the highest audio quality, and may be the most complex of all the audio modes to implement. FIG. 2 is an asynchronous mode dataflow diagram 200 of a USB system (e.g., the USB system 102), in accordance with certain aspects of the present disclosure. In the asynchronous mode, the USB host 110 may operate in the host clock domain based on the host clock 212, and the USB device 120 may operate on the device clock domain based on the device clock (MCLK) 222. The device clock may be referred to as the audio clock or MCLK 222. The USB host 110 may provide data (e.g., audio data) 210 to the USB device 120. The USB device 120 may provide explicit endpoint feedback 220 to the USB host 110. The USB device 120 may operate as directed by the control component 230. The control component 230 will be described further in connection with FIG. 3.

The asynchronous mode uses feedback (e.g., the endpoint feedback 220) from the USB device 120 to allow the USB device 120 to request the USB host 110 to adjust the data rate at which the USB host 110 provides the samples. For example, the USB host 110 may adjust the data rate at which the samples are provided to the USB device 120. In the asynchronous mode, the USB device 120 may operate on a free-running device clock MCLK 222. In one example, a free-running device clock MCLK 222 may be one where the USB device does not adjust the frequency or phase of the free-running device clock MCLK 222.

In the asynchronous mode, the USB device 120 may ask the USB host 110 to adjust the host clock 212 (e.g., to adjust the data rate of the data 210) via explicit feedback endpoints (e.g., via the endpoint feedback 220) without changing the device clock MCLK 222. Thus, the USB host 110 may be configured to handle the explicit feedback endpoint, and from the feedback data, the USB host 110 may decide how many samples to send over the data streaming endpoint in subsequent bus intervals (e.g., data rate).

As presented above, in the asynchronous mode, the endpoints in the USB device 120 may not be synchronized to the SOF signaling or any clock in the host clock domain. In one instance, the SOF signaling may operate in the host clock domain of the host clock 212, and the USB device may operate in the device clock domain of the device clock MCLK 222. The data rate of the endpoints may be locked to a clock external to the USB device 120 or to a free-running internal master clock MCLK 222 at the USB device 129. Asynchronous source endpoints in the USB host 110 may carry the data rate information implicitly in the number of samples produced per frame. Asynchronous sink endpoints in the USB device 120 may provide feedback 220 to the USB host 110 by indicating what the desired data rate (F_{f}) is, relative to the USB frame frequency. For example, the feedback may be provided as the number of samples per frame. The USB host 110 may continuously adjust the number of samples sent to the USB device 120 so that neither underflow nor overflow of the data buffer occurs, based on the feedback endpoint.

The USB device 120 may operate on a local, free-running clock MCLK 222, via which the USB device 120 determines how many (for example) audio samples are consumed by the USB device 120 in each service interval. A service interval (SI) may be, for example, a period in which the USB host 110 sends audio data to the USB device 120. The USB device 120 may implement the explicit feedback endpoint as well as the necessary logic to provide the correct feedback values to send the endpoint back to the USB host 110 via the endpoint feedback 220. The advantage of the asynchronous mode operation is that the USB device 120 may fairly and easily generates and relies upon a high-quality audio sample clock MCLK 222 (e.g., robust, stable, jitter-free, etc.). The MCLK 222 may be, for example, derived from a crystal-based clock.

The asynchronous implementation may utilize accurately both the host clock 212 and the device clock MCLK 222. The USB device 120 may obtain the host clock information via, for example, SOF time markers (e.g., time stamps) and obtain the device clock information via a timer or PLL running off the device clock MCLK 222. The asynchronous mode may generally be selected for HiFi audio applications. However, the implementation of the asynchronous mode may be device and vendor specific. If not designed properly, the asynchronous mode operation may cause system instability and lead to inferior audio quality. The audio buffer in system memory may undergo underflow or overflow error conditions as a result of clock mismatch between the clock domains. For example, not all host drivers (software) have the correct asynchronous driver code. The USB device 120 thus may need to recover from those faulty drivers.

For example, in Windows Vista and in Windows 7, usbaudio.sys driver supports synchronous, asynchronous, and adaptive endpoints. In Windows Server 2003 and earlier versions of Windows, usbaudio.sys supports adaptive and synchronous endpoints, but not asynchronous endpoints. Windows 7 native USB does not support implicit audio feedback, and may need to install third party software for the support. Mac OS supports several asynchronous feedback mechanisms. Early versions of Android do not support asynchronous method properly.

Further, due to noises on the USB data lines D+/D− (e.g., in the USB link 117), certain SOF events may be missed by the USB controller. Proper SOF recovery mechanism (e.g., a missing SOF detection mechanism) at the USB device may be needed to recover the missing SOF and to allow the USB device 120 to perform USB operations (e.g., audio playback) property.

Accordingly, this disclosure provides, inter alia, an system-on-chip (SOC), hardware solution that can resolve the estimation jitter from software based solutions. The described embodiments may detect and/or recover missing periodic packets in USB communication in an asynchronous environment. The periodic packets may be, for example, SOF, ACK, NACK, or other packets that the USB device 120 expects to receive at known time periods. In the presented embodiments, SOF is used as a non-limiting example of the periodic packets. Advantageously, the disclosed embodiments may not depend on any particular USB controller architecture (or serial interface engine in general), since the detection may be based on sniffing or reading the USB 2.0. Transceiver Macrocell Interface (UTMI) interface. Additionally, the detection may be based on reading signals on any interface after the USB physical (PHY) layer, such as the UTMI or the UTMI+ Low Pin Interface (ULPI). In the presented embodiments, UTMI interface is used as an example. Some embodiments may generate SOF and/or recovered SOF (RSOF) interrupts separate from the aforementioned USB controller.

FIG. 3 is a diagram 300 of a control component 230 of a USB device (e.g., the USB device 120), in accordance with certain aspects of the present disclosure. The diagram 300 includes a USB PHY layer 330, a periodic packet detection circuit 340, a USB controller 350, and a device controller 360. The USB PHY layer 330 may be connected to the USB link 117. The USB link 117 may be signal lines (e.g., data lines D+ and D−) that communicate with the USB host 110. For example, one or more signal lines of the USB link 117 may be adapted to carry USB signals in the host clock domain received from the USB host 110. In some embodiments, the host clock domain may be referred to as the first clock domain to differentiate from the device clock domain, which may be referred to as the second clock domain. The signal line or lines 370 couple to the USB PHY layer 330, the USB controller 350, and the periodic packet detection circuit 340. The signal line or lines 374 are coupled to the periodic packet detection circuit 340 and the device controller 360. The signal line or lines 372 are coupled to the USB controller 350 and the device controller 360.

In accordance with certain aspects of the present disclosure, the control component 230 of the USB device 120 may include a portion of the USB link 117 (e.g., a signal line or signal lines such as D+ and D−) adapted to carry signals (e.g., USB signals) in the host clock domain received from the USB host 110. The control component 230 may also include the device clock MCLK 222 operating the second clock domain. At least the device controller 360 may receive the device clock MCLK 222 to operate in the second clock domain. The device controller 360 may operate the USB device 120 in the second clock domain. For example, the device controller 360 may control the audio functions in the second clock domain, in a case that the USB device 120 is a headset. The device controller 360 may include various processing elements, such as a microcontroller unit. In some embodiments, the operations of the device controller 360 may be based on the associated firmware.

The USB PHY layer 330 may handle physical aspects of the signal lines of the USB link 117, such as receiving and transmitting the USB signals on the signal lines of the USB link 117, in compliance with USB specification. The USB PHY layer 330 may provide the USB signals carried on the signal lines of the USB link 117 (and received from the USB host 110) onto the signal line or lines 370 as UTMI signals. The USB controller 350 and the periodic packet detection circuit 340 are coupled to the signal line or lines 370 to read the UTMI signals. In some embodiments, both the USB controller 350 and the periodic packet detection circuit 340 may be directedly connected to the signal line or lines 370 to read the signals (e.g., USB data) on the signal line or lines 370.

In some embodiments, the clocking of the UTMI signals on the signal line or lines 370 (in the UTMI clock domain) may be referred to as the first clock domain to differentiate from the device clock domain (e.g., the second clock domain). Accordingly, the at least one signal line 370 may be adapted to carry signals (e.g., the USB data received from the USB host 110) as UTMI signals and in a first clock domain (e.g., the clocking of the UTMI signal).

The periodic packet detection circuit 340 may be adapted to detect a missing periodic packet from the signals received in the first clock domain (e.g., from the UTMI signals in the UTMI clocking). In some embodiments, the missing periodic packet may be an SOF packet. The periodic packet detection circuit 340 may read the UTMI signaling on the signal line or lines 370 to detect the missing SOF packet and provide outputs to the device controller 360 via the signal line or lines 374. The USB controller 350 may read the UTMI signaling on the signal line or lines 370 and generate interrupts for the device controller 360, via the signal line or lines 372.

In accordance with certain aspects of the disclosure, the control component 230 of the USB device 120 may include signal line or lines 370 adapted to carry UTMI signaling (e.g., of the USB signals carried by the USB link 117 and received from the USB host 110). The USB controller 350 may be adapted to decode packet identification (PID) in the UTMI signals on the signal line or lines 370. For example, the USB controller 350 may detect the PID of the packets carried on the signal lines of the USB link 117 by recognizing the PID in the UMTI signals. In one instance, the USB controller 350 may detect the SOF packet based on the recognized PID and generate the SOF interrupt. The USB controller 350 may provide the SOF interrupt to the device controller 360 via the signal line or lines 370. The periodic packet detection circuit 340, separate from the USB controller 350, may be adapted to decode the PID in the UTMI signals independent from the USB controller 350 decoding the PID. Thus, in some embodiments, the periodic packet detection circuit 340 may duplicate in part the PID detection performed by the USB controller 350. These features will be presented in further details below.

Certain USB general features are present below. By way of example, the SOF packet is presented here as an example of the periodic packet. As provided above, the term “frame” may refer to a set time period, such as a frame and/or a microframe within the USB context. For example, a USB frame may be 1 ms for the low/full-speed bus. A USB microframe may be 125 μs for the high-speed bus.

The SOF packets may be issued by the USB host 110 at a nominal rate of once every 1.00 ms ±0.0005 ms (e.g., every frame) for the full-speed bus and 125 μs±0.0625 μs (e.g., every microframe) for the high-speed bus. The SOF packets may include of a PID indicating packet type followed by an 11-bit frame number field. The data Service Interval (SI) is the period between consecutive requests to a USB endpoint (e.g., the USB host 110 or the USB device 120) to send or receive data. The SI may be set by the data endpoint descriptor “bInterval,” and the value may range from 1-16. The service interval may be 2̂(bInterval−1) frames or microframes. The feedback end point polling interval (polling interval) is the time period between feedback word updates (e.g., via the endpoint feedback 220). The polling interval may also be a power-of-2 number of frame or microframes and may be no shorter than the data endpoint SI.

The audio quality in the asynchronous mode may be affected by the accuracy of the feedback work. The feedback word may be derived from the estimation of the USB device audio clock frequency (e.g., MCLK 222) in reference to the USB SOF. For example, the feedback word may be derived from identifying a number of audio clock count for a time period timed with the SOF. In one example, the USB device 120 may include a counter that counts the MCLK 222 (i.e. audio clock). The output of the counter is latched at every polling interval. The latch may be followed by a differentiator, which provides the number of device clock transitions within a polling interval.

To generate the desired data rate F_{f} for the feedback, the device may measure its actual sampling rate Fₛ (e.g., a rate at which the USB device 120 consumes the USB data), referenced to the USB notion of time (e.g., the USB frame frequency). Therefore, the trigger for latching the audio timer may be derived from the USB timing (e.g., the SOF). The data rate F_{f} may be expressed in number of samples per frame or per micro frame (e.g., for USB specification) or per SI (e.g., Thyscon driver for Windows, Linux implementation).

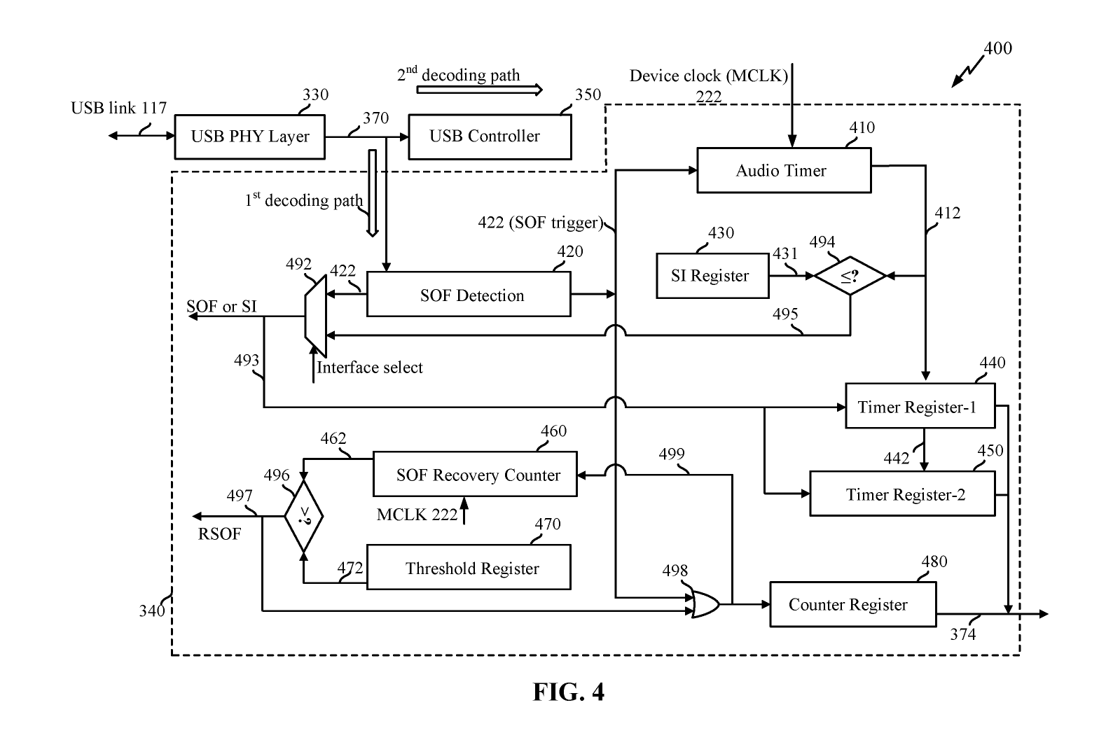

FIG. 4 is a diagram 400 of a periodic packet detection circuit (e.g., the periodic packet detection circuit 340) of a USB device (e.g., the USB device 120), in accordance with certain aspects of the present disclosure. The periodic packet detection circuit 340 may include or operate on the device clock (MCLK) 222. The MCLK 222 may be a free-running clock. For example, the USB device 120 may not adjust the frequency or phase of the MCLK 222. Such free-running clock may be more accurate because, for example, the fractional MCLK 222 of each frame period accumulates over time. In contrast, a timer that stops and restarts with SOF trigger does not accumulate the fractional time periods. The MCLK 222 may, for example, run at 9.6 MHz.

The periodic packet detection circuit 340 may receive inputs, such as the UTMI signals or signaling of the USB signals received on the USB link 117. The periodic packet detection circuit 340 may output to the device controller 360 via the signal line or lines 374. In the diagram 400, the signal line or lines 493 and/or 497 may be part of the signal line or lines 374.

The periodic packet detection circuit 340 may include an audio timer 410, an SOF detection circuit 420, an SI register 430, a timer register-1 440, a timer register-2 450, an SOF recovery counter 460, a threshold register 470, and a counter register 480. The registers may be accessible or programmable by the device controller 360 via, for example, software interface. The periodic packet detection circuit 340 may further include logic elements such as the multiplexer 492, the comparators 494 and 496, and the OR logic element 498. Each of the logic elements may include one or more logic gates or be implemented in other fashions. The comparators 494, 496 may be digital comparators, and not the analog kind. The logic elements may be implemented with any known schemes in the art.

The audio timer 410 may operate on the MCLK 222 and latch the MCLK 222 as time stamps at every detected SOF (e.g., from the SOF detection circuit 420). In one instance, the operations of the control component 230 may rely on the time stamps latched at the polling interval. More frequent updates of the feedback word may lead to tighter control of the rate adaptation and better over audio performance. However, the tradeoff is increased processing load of the device controller 360. To allow the flexibility, the control component 230 may provide hooks to trigger the device controller 360 processing once per configurable timer period (e.g., multiple of SOFs and aligned to polling intervals). As presented above, the USB data on the USB link 117 may be corrupted and/or the SOF may be missing. The control component 230 (e.g., the periodic packet detection circuit 340) may be adapted to detecting a missing periodic packet (e.g., a missing SOF packet) with or without additional device controller 360 operations.

At each SOF, the time stamp at a polling interval may be loaded to the timer register-1 440 via the signal line or lines 412. At a subsequent SOF, the time stamp at the timer register-1 440 may be loaded onto the timer register-2 450 via the signal line or lines 442. Thus, the timer register-1 440 may store the time stamp of the latest SOF, and the timer register-2 450 may store the time stamp from the previous SOF. The delta of the two SOF time stamps may be the count of the audio clock (MCLK 222) within an SOF.

At a start of the USB device 120 operation (e.g., start of audio playback), the device controller 360 may read the timer register-1 440 containing the SOF time stamp of the latest SOF (or SI or polling interval) to establish the first timing reference. Subsequently, the device controller 360 may wait for a polling interval, which may contain multiple SOFs, plus some small delta time to read the next SOF time stamp. That is, the device controller 360 may not read all SOF time stamps and may read only the time stamps latched at polling intervals.

To allow the device controller 360 to wake up at SOF (or SI or polling period)(e.g., via firmware), a wake-up interrupt may be used. The wake-up interrupt may occur at a configurable time based on the free running audio timer 410. The wake-up interrupt may be implemented by the firmware associated with the device controller 360.

As audio clock frequency is not locked to the USB timing (e.g., the MCLK 222 operates in the device clock domain different from the host clock domain), the number of audio clock counts within a polling interval may change. In order for the device controller 360 to wake up at proper timing and without the need to account for firmware latency, the device controller 360 may calculate the next wake up time from the last known time reference (e.g. the last SOF time stamp) plus the last known audio clock count within a polling period and a small delta estimated from the worst case drift (e.g., 40 ppm).

The SOF detection circuit 420, separate from the USB controller 350, may decode the UTMI signals on the signal line or lines 370. For example, the SOF detection circuit 420 may detect the PID of the packets carried on the signal lines of USB link 117 by recognizing the PID in the UMTI signals. In one instance, the SOF detection circuit 420 may detect the SOF from the PID and output the SOF trigger onto the signal line or lines 422. The audio timer 410 is coupled to the signal line or lines 412 such that the audio timer 410 may latch the time stamp of the MCLK 222 at each SOF trigger. In a case of a missing SOF, the audio timer 410 would not latch the time stamp of the MCLK 222. The multiplexer 492 is also coupled to the signal line or lines 422.

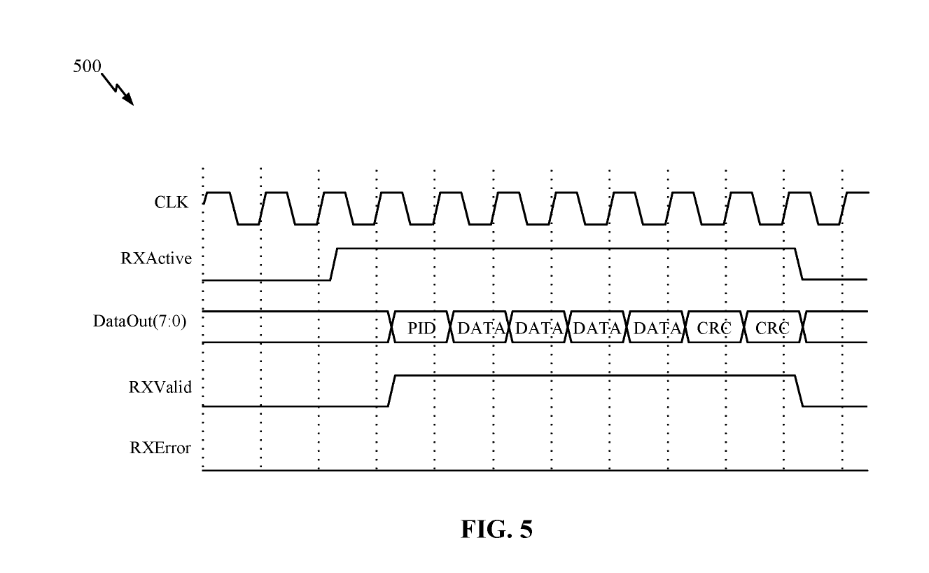

FIG. 5 is a diagram 500 of decoding packet identification from UTMI signaling, in accordance with certain aspects of the present disclosure. The USB controller 350 and/or the SOF detection circuit 420 may read the UTMI signaling (of the USB signals on the USB link 117) on the signal line or lines 370. The diagram 500 includes the UTMI signals CLK, RXActive, DataOut(7:0), RXValid, and RXError. The DataOut(7:0) may carry PID, data, and cyclic redundancy check (CRC) of a USB packet in a serial fashion.

In some embodiments, the USB controller 350 and/or the SOF detection circuit 420 may read and detect the periodic packet (e.g., SOF packet) from the PID on the DataOut(7:0). Moreover, the USB controller 350 and/or the SOF detection circuit 420 may operate in the UTMI clock domain for detecting the PID. For example, the RXActive and/or the RXValid may be used as trigger to detect the PID. In some embodiments, the UTMI clock domain may be referred to as a first clock domain to differentiate the device clock domain (i.e., the second clock domain).

Referring back to FIG. 4, the SI register 430 may store a time stamp that correspond to the SI for waking up the device controller 360. The device controller 360 may be able to program the SI register 430 via, for example, software interface for various SIs of different USB operations. In some embodiments, the audio timer 410 may latch the time stamp of the MCLK 222 in response to the SOF trigger on the signal line or lines 422, and provide the latched time stamp onto the signal line or lines 412.

The comparator 494 may compare the SI register value on the signal line or line 431 and the latched time stamp onto the signal line or lines 412. In a case that the latched time stamp is greater or equal to the SI register value, the comparator 494 may issue the SI-detect signaling onto the signal line or lines 495. The comparator 494 may perform the compare function digitally.

The multiplexer 492, controlled by the interface select signal, may be coupled to the signal line or lines 422 and the signal line or lines 495. The multiplexer 492 may select between the SOF trigger on the signal line or lines 422 and the SI-detect signaling on the signal line or lines 495 to output to the signal line or lines 493. In such fashion, the SOF trigger and the SI-detect signaling may share one or a set of signal lines 493. The signal line or lines 493 (as part of the signal line or lines 374) may be provided to the device controller 360 as an SOF or SI interrupt.

In some embodiments, the periodic packet detection circuit 340 may include the SOF recovery counter 460 and the threshold register 470 to generate a recovery SOF trigger. The SOF recovery counter 460 may operate on the MCLK 222 and therefore, may operate in the second clock domain. The logic element 498 may OR the recovered SOF (RSOF) trigger or interrupt on the signal line or lines 497 and the SOF trigger on the signal line or lines 422 and outputs onto the signal line or lines 499. The SOF recovery counter 460 may receive the output of the logic element 498 and increase the count (based on the MCLK 222). Thus, the SOF recovery counter 460 may increase the count each time the SOF is detected (SOF trigger) and the RSOF trigger or interrupt is generated. The SOF recovery counter 460 may output the count onto the signal line or lines 462.

The threshold register 470 may store a value representing a count of the MCLK 222 when a periodic packet, such as the SOF packet, is expected. The threshold register 470 may output the value onto the signal line or lines 472. The device controller 360 may program the threshold register 470 for various values for different USB operation modes in which the expected MCLK 222 counts for the SOF packet may differ.

The comparator 496 may compare the SOF recovery counter 460 count on the signal line or lines 462 and the threshold register 470 count on the signal line or lines 472. In a case that the SOF recovery counter 460 count is greater than the threshold register 470 count, for example, the comparator 496 may output the RSOF trigger or interrupt onto the signal line or lines 497. The RSOF trigger or interrupt on the signal line or lines 497 may be provided to the device controller 360 (e.g., the signal line or lines 497 may be part of the signal line or lines 374). The RSOF trigger or interrupt may be in the first clock domain as the SOF recovery counter 460 operates in the second clock domain.

The counter register 480 may receive the output of the logic element 498 on the signal line or lines 499. In this fashion, the counter registers 480 may increment its count for each SOF trigger (e.g., in the first clock domain) and for each RSOF trigger (e.g., in the second clock domain). The counter register 480 may output the count to the signal line or lines 374 to the device controller 360. In some examples, the device controller 360 may use the counter register 480 to determine if the time stamps (e.g., in the timer register-1) are read at the proper interval. The counter register 480 may be used as a reference for such determinations.

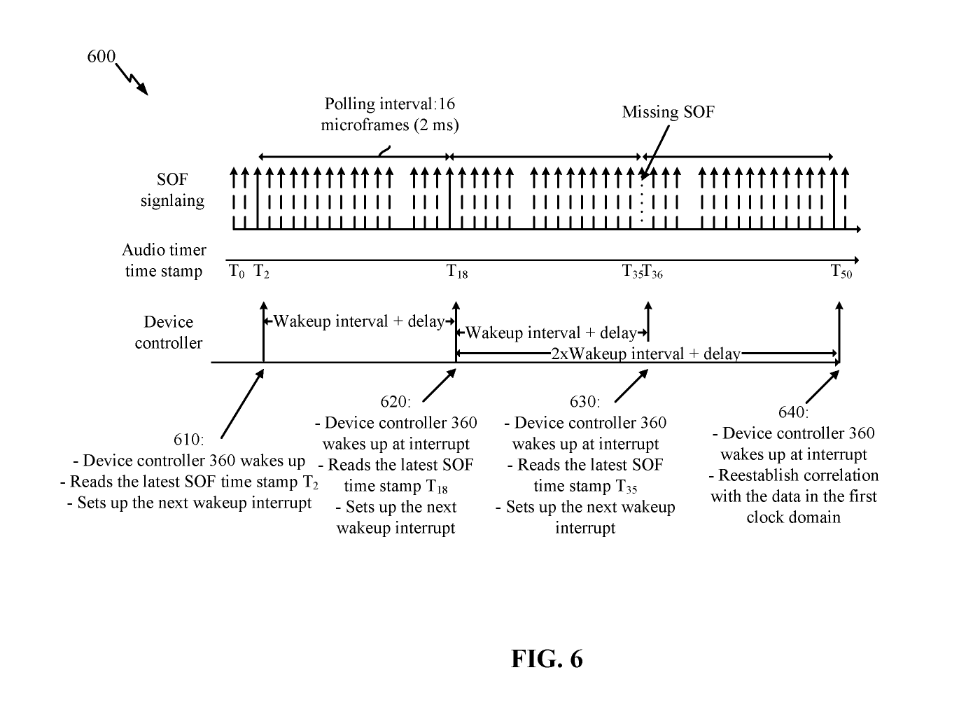

FIG. 6 is a diagram 600 of certain operations of a device controller (e.g., the device controller 360), in accordance with certain aspects of the present disclosure. The timing diagram 600 provides an example where the USB system 102 operates on a USB high-speed bus. By way of example, the USB host 110 may transmit SOF signaling (e.g., transmit an SOF packet) for the audio data at each microframe, and the polling interval may include 16 microframes. Each of the microframe may be 125 μs, and each of the polling period may be 2 ms. The polling intervals generally correspond to the audio timer time stamps T₂, T₁₈, T₃₆, T₅₀, etc., plus a time delay delta_t. Further, at each polling interval, the timer register-1 440 and/or the timer register-2 450 may be updated (e.g., controlled by the device controller 360).

Initially, at 610, the device controller 360 may wake up (e.g., as dictated by firmware) and read the latest SOF time stamp, T₂, stored in the timer register-1 440. In some examples, the device controller 360 may initially wake up at an arbitrary time. E.g., the initial wake up time is unrelated to or is independent of the USB audio data (which is indicated by the SOF signaling). The device controller 360 may set up the next wakeup interrupt at, for example, a wakeup interval plus the time delay delta_t for the next polling interval. The device controller 360 may update the timer register-1 440 by loading the SOF time stamp (T₂) into the timer register-1 440. Between 610 and 620 (e.g., between the time stamps T₂ and T₁₈), as an example, the periodic packet detection circuit 340 may properly receive and recognize all the SOF signaling.

At 620, the device controller 360 may wake up (e.g., as dictated by firmware) and update the timer register-1 440 and/or the timer register-2 450. Thus, the timer register-1 440 may store T₁₈, and the timer register-2 450 may store T₂. The device controller 360 may determine, based on the timer register-1 440 and/or the timer register-2 450, that no missing periodic packet (e.g., the SOF packet) was detected in the polling interval. The device controller 360 may update the endpoint feedback 220 accordingly.

The device controller 360 may set up the next wakeup interrupt at, for example, the wakeup interval plus delay delta_t. Between 620 and 630 (e.g., between the time stamps T₁₈ and T₃₆), as an example, the periodic packet detection circuit 340 may fail to receive and/or decode a SOF packet.

At 630, the device controller 360 may wake up (e.g., as dictated by firmware) and update the timer register-1 440 and/or the timer register-2 450. Thus, the timer register-1 440 may store T₃₅, and the timer register-2 450 may store T₁₈. The device controller 360 may determine, based on the timer register-1 440 and/or the timer register-2 450, that at least one missing periodic packet (e.g., the SOF packet) was detected in the polling interval. To correlate an operation in the second clock domain (e.g., the audio playback) with the first clock domain (e.g., the audio data in the UTMI clock domain), based on the periodic packet detection circuit 340 detecting the missing periodic packet (e.g. the missing SOF at T₁₈), the device controller 360 may skip updating the endpoint feedback 220. Accordingly, the last known good feedback word may be used for the endpoint feedback 220.

The device controller 360 may further correlate an operation in the second clock domain (e.g., the audio playback) with the data in the first clock domain (e.g., the audio data in the UTMI clock domain) by reestablish or restoring a timing relationship between the device controller 360 and the audio data in the UTMI clock domain. For example, the device controller 360 via the firmware may set up the next wakeup interrupt from the known SOF time stamp, such as T₁₈. The wakeup interrupt may be set at a two times wakeup interval plus delay delta_t, for example.

In some examples, the example of the USB high speed mode, the disclosed example may operate for the case that the missing SOF signaling being at the polling interval. For example, any missing SOF signaling between 620 and 630 (e.g., time stamps T₁₉-T₃₅) would not trigger the device controller 360 detecting a missing SOF packet at the polling interval.

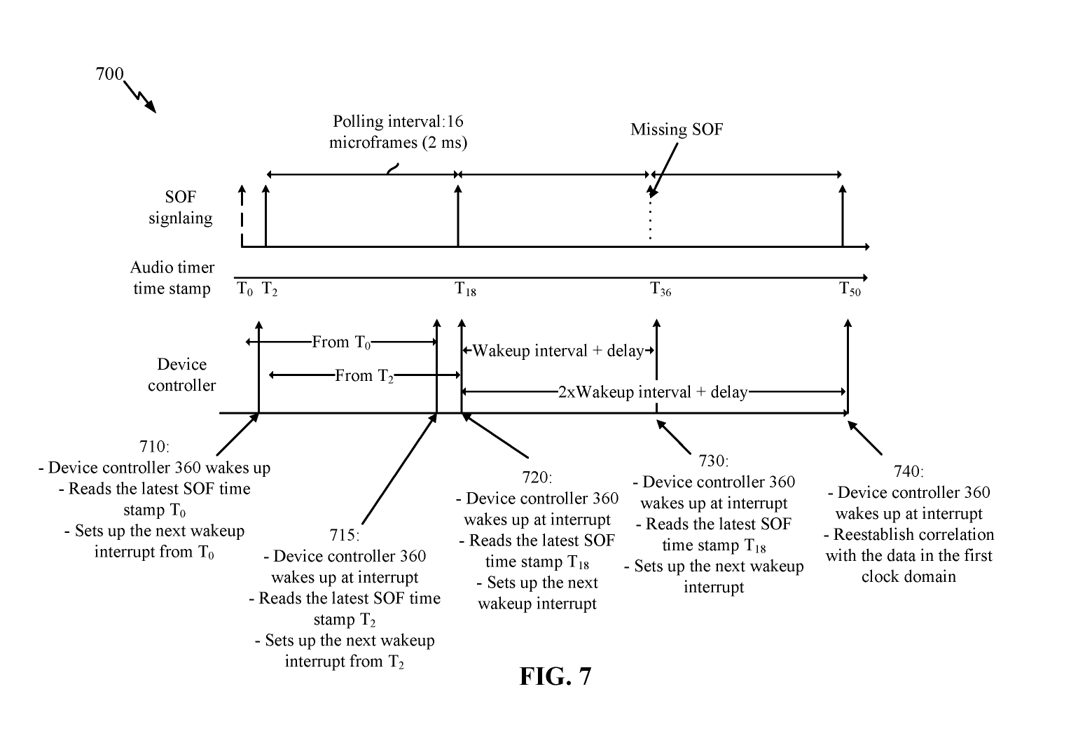

FIG. 7 is a diagram 700 of certain operations of a device controller (e.g., the device controller 360), in accordance with certain aspects of the present disclosure. The timing diagram 700 provides an example where the USB system 102 operates in a frame of 2 ms. By way of example, the USB host 110 may transmit SOF signaling (e.g., transmit an SOF packet) for the audio data at every frame (e.g., every 2 ms), and the polling interval may be 2 ms. The polling intervals generally correspond to the audio timer time stamps T₂, T₁₈, T₃₆, T₅₀, etc., plus a time delay delta_t. Further, at each polling interval, the timer register-1 440 and/or the timer register-2 450 may be updated (e.g., controlled by the device controller 360).

Initially, at 710, the device controller 360 may wake up (e.g., as dictated by firmware) and read the latest SOF time stamp, T₀, stored in the timer register-1 440. In some examples, the device controller 360 may initially wake up at an arbitrary time. E.g., the initial wake up time is unrelated to or is independent of the USB audio data (which is indicated by the SOF signaling). The device controller 360 may set up the next wakeup interrupt 715 for the next polling interval at, for example, a wakeup interval plus the time delay delta_t from the time stamp T₀. The device controller 360 may update the timer register-1 440 by loading the SOF time stamp (T₀) into the timer register-1 440.

At 715, the device controller 360 may wake up (e.g., as dictated by firmware) and update the timer register-1 440 and/or the timer register-2 450. Thus, the timer register-1 440 may store T₂, and the timer register-2 450 may store T₀. The device controller 360 may determine, based on the timer register-1 440 and/or the timer register-2 450, that no missing periodic packet (e.g., the SOF packet) was detected in the polling interval. That is, an SOF signal was detected at T₂. The device controller 360 may update the endpoint feedback 220 accordingly. The device controller 360 may set up the next wakeup interrupt 720 for the next polling interval at, for example, a wakeup interval plus the time delay delta_t from the time stamp T₂.

At 720, the device controller 360 may wake up (e.g., as dictated by firmware) and update the timer register-1 440 and/or the timer register-2 450. Thus, the timer register-1 440 may store T₁₈, and the timer register-2 450 may store T₂. The device controller 360 may determine, based on the timer register-1 440 and/or the timer register-2 450, that no missing periodic packet (e.g., the SOF packet) was detected in the polling interval. That is, an SOF signal was detected at T₁₈. The device controller 360 may update the endpoint feedback 220 accordingly. The device controller 360 may set up the next wakeup interrupt 730 for the next polling interval at, for example, a wakeup interval plus the time delay delta_t from the time stamp T₁₈.

The SOF signal at time stamp T₃₆ may be missing. At 730, the device controller 360 may wake up (e.g., as dictated by firmware) and update the timer register-1 440 and/or the timer register-2 450. Thus, the timer register-1 440 may store T₁₈, and the timer register-2 450 may store T₁₈. The device controller 360 may determine, based on the timer register-1 440 and/or the timer register-2 450, that at least one missing periodic packet (e.g., the SOF packet) was detected in the polling interval. To correlate an operation in the second clock domain (e.g., the audio playback) with the first clock domain (e.g., the audio data in the UTMI clock domain), based on the periodic packet detection circuit 340 detecting the missing periodic packet (e.g. the missing SOF at T₃₆), the device controller 360 may skip updating the endpoint feedback 220. Accordingly, the last known good feedback word may be used for the endpoint feedback 220.

The device controller 360 may further correlate an operation in the second clock domain (e.g., the audio playback) with the data in the first clock domain (e.g., the audio data in the UTMI clock domain) by reestablish or restoring a timing relationship between the device controller 360 and the audio data in the UTMI clock domain. For example, the device controller 360 via the firmware may set up the next wakeup interrupt 740 from the known SOF time stamp, such as T₁₈. The wakeup interrupt may be set at a two times wakeup interval plus the delay delta_t, for example.

In some embodiments, the device controller 360 may stop the audio processing and reset the registers in the line is determined to be too noisy. For example, if too many consecutive missing SOFs are detected (e.g., exceeding a threshold of missing SOFs)), the device controller 360 may consider the line to be too noisy.

In some embodiments, the audio clock count (e.g., the time stamps) between two SOFs may be bound by the maximum clock offset between the audio clock (MCLK 222) and a USB clock. Table 1 below lists the range of the clock counts per frame for a full-speed bus and per microframes for a high-speed bus. The MCLK 222 in the example runs at 9.6 Mhz, and a microframe is 125 μs.

TABLE 1

| | | | MCLK | | | | | | |
|---|---|---|---|---|---|---|---|---|---|
| | | Service | count/ | MCLK | | | | | |
| USB | | interval | service | drift | Delta | Delta | | Guard | |
| bus | bInterval | (μs) | interval | (ppm) | (+) | (−) | TH | % | TH2 |
| High | 1 | 125 | 1200 | 1000 | 1201.2 | 1198.8 | 1202 | 10 | 1323 |
| Full | 8 | 1000 | 9600 | 1000 | 9609.6 | 9590.4 | 9610 | 10 | 10571 |

The bInterval is the endpoint descriptor provided in the USB specification. The TH (threshold) is a threshold count used to update the SI register 430 and/or the SI threshold register 470 by the device controller 360 to trigger the next SOF/SI interrupt, for example. For example, the device controller 360 may include an interrupt service routine to update the SI register 430 with the timer register-2 450 plus the TH.

In some examples, to generate an interrupt for every microframe SOF, the TH may be the integer upper bounds of Delta+ and Delta−. For example, the Delta+ (or Delta−) may be the MCLK count times (1+ppm)(or 1−ppm). For high-speed USB bus:

Delta+=1200×(1+1000×1e⁻⁶)=1201.2;

Delta−=1200×(1−1000×1e⁻⁶)=1198.8;

TH=int(1201.2)=1202.

For full-speed USB bus:

Delta+9600×(1+1e⁻⁶)−9609.6;

Delta−=9600×(1−1e⁻⁶)=9590.4;

TH−int(9609.6)=9610.

The guard 10% is used to allow further delay margin to trigger interrupt to the device controller 360. The TH2 is the TH with the 10% margin. For high-speed USB bus:

TH2=TH×(1+10%)=1202×1.1=1322.2→1323.

For full-speed USB bus:

TH2=TH×(1+10%)=9610×1.1=10571.

To generate an interrupt for every 2 ms of SI (e.g., 16 SOFs for high-speed USB bus or 2 SOFs for full-speed USB bus) for both high-speed and full-speed USB bus:

Delta+=9600×2×(1+1e⁻⁶)=19219.2;

Delta−=9600×2×(1−1000×1e⁻⁶)=19180.8;

TH=int(19219.2)=19220;

TH2=TH×(1+10%)=19220×1.1=21142.

In some embodiments, the device controller 360, via firmware, may detect a missing periodic packet (e.g., the SOF packet) by calculating the count of audio clock for a microframe. For example, using the high-speed bus, the nominal count may be the MCLK 222 frequency divided by 8000 (the number of microframes in a second). For the full-speed bus, the nominal count may be the MCLK 222 frequency divided by 1000 (the number of frames in a second). The worst case frequency offset based on the USB standard requirement is 1000 ppm. Taking the offset into account, the count per microframe may be between 1198 and 1202 for the high-speed bus, and between 9590 and 9610 for the full-speed bus. See Table 1. In one example, the device controller 360, via firmware, may determine that a periodic packet (e.g., the SOF packet) is missing in a case that the calculated audio clock count falls below the lower limits.

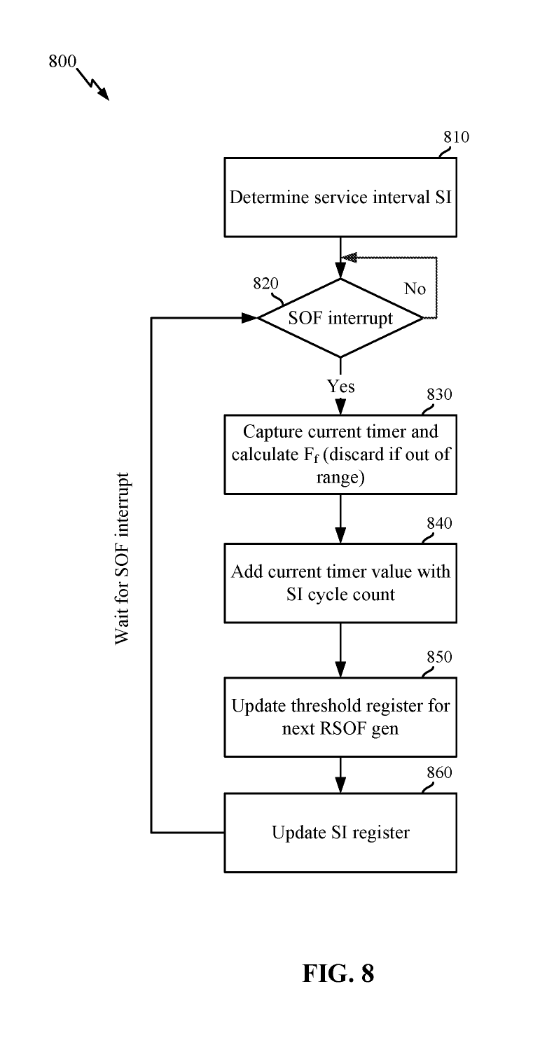

FIG. 8 is a flow diagram 800 of certain operations of a device controller (e.g., the device controller 360), in accordance with certain aspects of the present disclosure. In some examples, the flow diagram 800 may provide an example of the flow of the operations described in FIG. 7. At 810, the device controller 360 may determine the service interval SI, based on the operating modes of the USB system 102. At 820, the device controller 360 may determine whether an SOF interrupt or an RSOF interrupt is generated. For example, the device controller 360 may receive or monitor the signal lines 493 and 497 for the interrupts. If the device controller 360 determines that no SOF interrupt or RSOF interrupt was generated, the device controller 360 may remain idle.

If the device controller 360 determines that an SOF interrupt or an RSOF interrupt was generated, the flow proceeds to 830. At 830, the device controller 360 may capture current timer and calculate the date rate F_{f} for the endpoint feedback 220. For example, referring to FIG. 7, the device controller 360 at 720 may read the time stamps in the timer register-1 440 and/or the timer register-2 450. The device controller 360 may calculate or update the date rate F_{f} for the endpoint feedback 220 in a case that no missing periodic packet (e.g., the SOF packet) was detected. Moreover, the device controller 360 at 730 may skip the updating the date rate F_{f} for the endpoint feedback 220 in a case that a missing periodic packet (e.g., the SOF packet) was detected.

At 840, the device controller 360 may add the current timer value with the SI cycle count. For example, the device controller 360 may add the count of the timer register-1 440 and/or the timer register-2 450 to the count of the SI register 430 to advance the SI count. At 850, the device controller 360 may update the threshold register (e.g., the threshold register 470) for the next RSOF generation. At 860, the device controller 360 may update the SI register. For example, the device controller 360 may store the count from 840 to the SI register 430. After 860, the device controller 360 may return to 820 to wait for the next SOF interrupt.

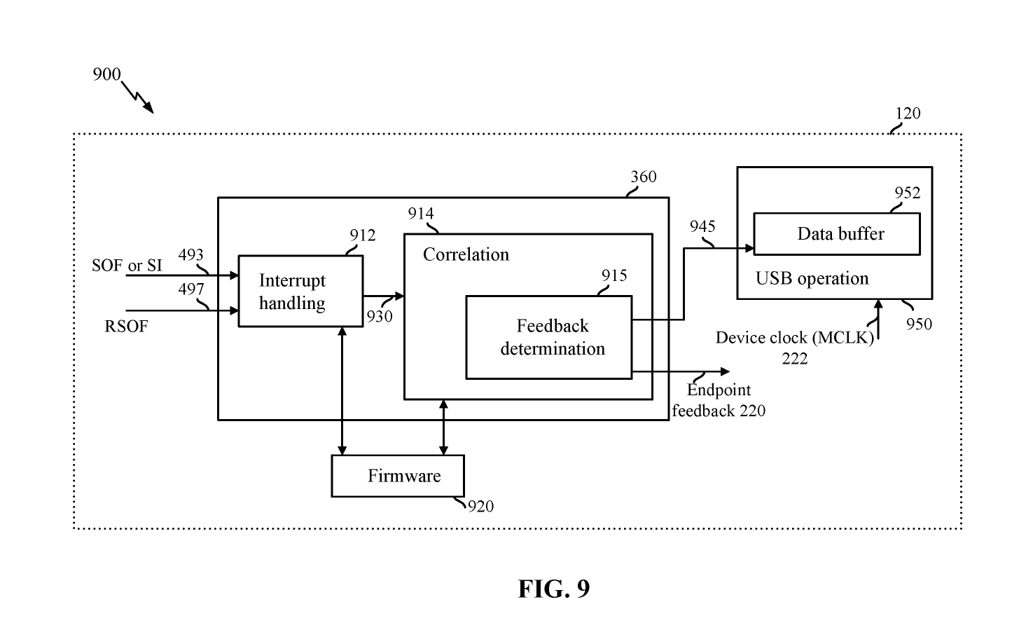

FIG. 9 is a diagram 900 of a device controller (e.g., the device controller 360), in accordance with certain aspects of the present disclosure. The diagram 900 includes the USB device 120, which is illustrated to include the device controller 360 and the USB operation component 950. The USB operation component 950 may be configured to handle the USB operations (e.g., audio playback) of the USB device 120. The USB operation component 950 may receive the MCLK 222 such that the USB operations (e.g., audio playback) operate in the second clock domain. In some embodiments, the USB operation component 950 may include a data buffer 952. The data buffer 952 may store, for example, the audio samples received from the USB host 110 (e.g., via the USB link 117 and/or the UTIMI signaling on the signal line or lines 370).

The device controller 360 includes the interrupt handling component 912, a correlation component 914. The correlation component 914 includes the feedback determination component 915. The operations of the device controller may be directed by or based on, in part, by the firmware 920. The device controller 360 may be configured to perform the functions described with FIGS. 3-8.

The interrupt handling component 912 may receive the signal lines 493 and 497 (which may be part of the signal line or lines 374 to receive the SOF or SI interrupt and the RSOF interrupt. In some embodiments, the interrupt handling component 912 may be configured to wake up portions of the device controller 360 in response to the SOF or SI interrupt and/or the RSOF interrupt. In some other embodiments, the interrupt handling component 912 may be configured to wake up portions of the device controller 360 in response a polling interval determined by the firmware 920 (for example, waking up the portions of the device controller 360 for every SOF and/or RSOF interrupts, as described with FIG. 6). The interrupt handling component 912 may output to the correlation component 914 via the signal line or lines 930.

In some embodiments, the correlation component 914 may be adapted to correlate an operation in the second clock domain (e.g., audio playback in the MCLK 222 clock domain) with the first clock domain (e.g., the UMTI clock domain or the host clock domain of the signals received on the USB link 117), based on the periodic packet detection circuit 340 detecting the missing periodic packet (e.g., a SOF packet). For example, the correlation component 914 may include a feedback determination component 915. The feedback determination component 915 may be adapted to determine a feedback (e.g., data rate F_{f} via the endpoint feedback 220) to the USB host 110 to allow the USB host 110 to adjust a transmission rate of the data on the USB link 117. The feedback determination component 915 may determine or calculate the feedback based on the periodic packet detection circuit 340 detecting the missing periodic packet (e.g., a SOF packet). For example, the feedback determination component 915 may not determine or calculate the feedback in a case the periodic packet detection circuit 340 detecting the missing periodic packet (e.g., a SOF packet).

In some embodiments, the feedback determination component 915 may determine or calculate the feedback (e.g., via endpoint feedback 220) to the USB host 110 based on the recovered periodic packet signaling (e.g., the RSOF interrupt generated by the periodic packet detection circuit 340). For example, referring to FIG. 5, the interrupt handling component 912 may count sixteen SOF interrupts and RSOF interrupts to wake up the portions of the device controller 360. Upon waking up, the feedback determination component 915 may then determine or calculate the feedback. The USB host may rely on the feedback (e.g., the endpoint feedback 220) to adjust transmission of data rate (e.g., the data provided on the USB link 117).

The feedback determination component 915 may determine or calculate the data rate F_{f} for the endpoint feedback 220. The data rate F_{f} may, for example, include a number of data (e.g., audio samples) in a polling interval. The feedback determination component 915 may calculate the data rate F_{f} based on a rate the USB device 120 consumes the data received on the USB link 170 (e.g., an audio playback rate) and the data remaining in the data buffer 952. The feedback determination component 915 may read the data buffer 952 via the signal line or lines 945.

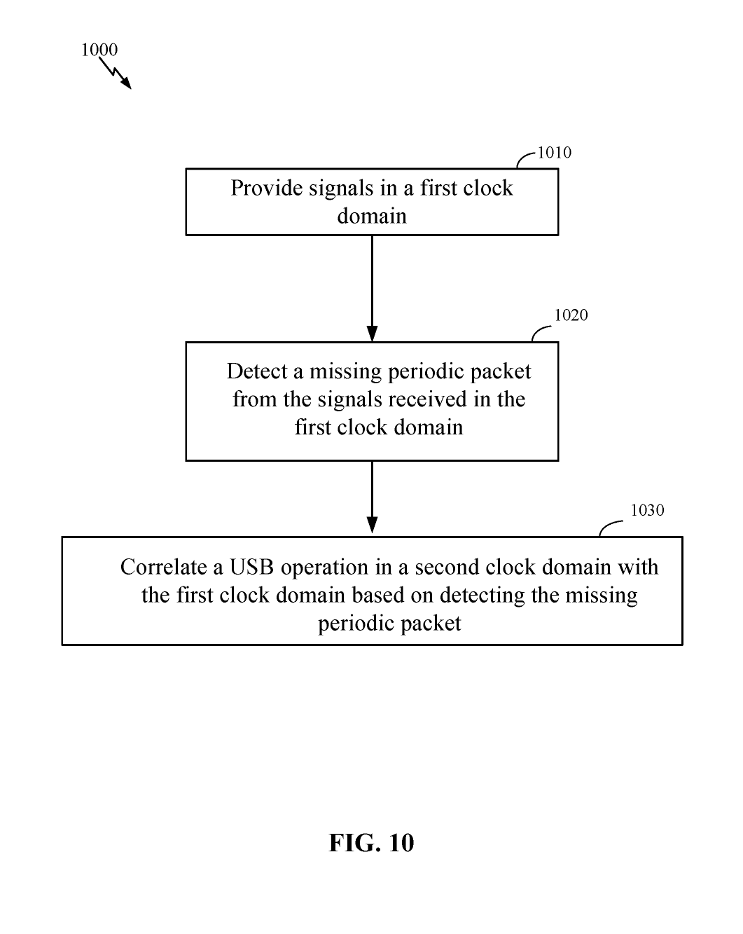

FIG. 10 is a flow diagram 1000 of example operations of a USB device (e.g., the USB device 120), in accordance with certain aspects of the present disclosure. The operations may be performed, for example, by the components presented in FIGS. 3, 4, and 9. At 1010, signals are provided in a first clock domain. For example, referring to FIG. 4, the USB PHY layer may receive USB data on the USB link 117, from the USB host 110. The USB data may be audio data. The USB PHY layer 330 may provide the data received from the USB host 110 as UTMI signals (or ULPI signals) in the UTMI clock domain (or ULPI clock domain).

At 1020, a missing periodic packet from the signals received in the first clock domain is detected. For example, as described with FIG. 7, the device controller 360 may detect a missing SOF packet by reading the counts in the timer register-1 440 and/or the timer register-2 450. Referring to FIG. 4, the SOF detection circuit 420 may generate the SOF trigger by reading the UTMI signals (in the first clock domain), and the SOF trigger operate the counts in the timer register-1 440 and/or the timer register-2 450.

At 1030, a USB operation in a second clock domain is correlated with the first clock domain based on detecting the missing periodic packet. the correlation component 914 may be adapted to correlate an operation in the second clock domain (e.g., audio playback in the MCLK 222 clock domain) with the first clock domain (e.g., the UMTI clock domain or the host clock domain of the signals received on the USB link 117), based on the periodic packet detection circuit 340 detecting the missing periodic packet (e.g., a SOF packet). For example, the correlation component 914 may include a feedback determination component 915. The feedback determination component 915 may be adapted to determine a feedback (e.g., data rate F_{f} via the endpoint feedback 220) to the USB host 110 to allow the USB host 110 to adjust a transmission rate of the data on the USB link 117. The feedback determination component 915 may determine or calculate the feedback based on the periodic packet detection circuit 340 detecting the missing periodic packet (e.g., a SOF packet). For example, the feedback determination component 915 may not determine or calculate the feedback in a case the periodic packet detection circuit 340 detecting the missing periodic packet (e.g., a SOF packet).

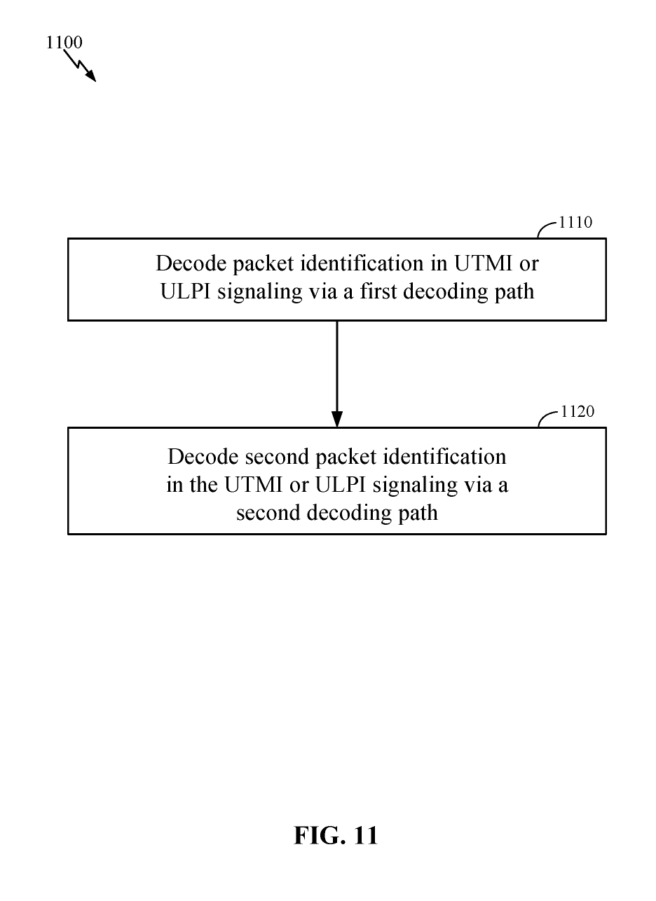

FIG. 11 is a flow diagram 1100 of example operations of a USB device (e.g., the USB device 120), in accordance with certain aspects of the present disclosure. The operations may be performed, for example, by the components presented in FIGS. 3, 4, and 9. At 1110, packet identification in UTMI or ULPI signaling is decoded via a first decoding path. For example, referring to FIG. 4, the USB PHY layer 330 may provide the data received from the USB host 110 as UTMI signaling (or ULPI signaling) in the UTMI clock domain (or ULPI clock domain) to the signal line or lines 370. The UTMI signaling (or ULPI signaling) may be decoded in a first decoding path. For example, the first decoding path may be via the SOF detection circuit 420. The SOF detection circuit 420 may read the UTMI signaling (or ULPI signaling) and decode the decode the PID of the packets therein. See, for example, FIG. 5 and the associated descriptions.

At 1120, packet identification in UTMI or ULPI signaling is decoded via a second decoding path. For example, the second decoding path may be via the USB controller 350. The USB controller 350 may read the UTMI signaling (or ULPI signaling) and decode the PID of the packets therein. See, for example, FIG. 5 and the associated descriptions. The first decoding path and the second decoding path may be independent. For example, the SOF detection circuit 420 reading and decoding the UTMI signaling (or ULPI signaling) may not be dependent on the USB controller 350 reading the decoding the UTMI signaling (or ULPI signaling), and vice versa.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

The blocks, modules, components, circuits, and functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented. The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims. For example, the steps may be implemented by circuits to perform the functions described herein and/or circuits generating the signals for the functions described herein, or combinations thereof. The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A Universal Serial Bus (USB) device, comprising:
at least one signal line adapted to carry signals in a first clock domain, the signals being received from a USB host;
a clock operating a second clock domain;
a periodic packet detection circuit adapted to detect a missing periodic packet from the signals received in the first clock domain; and
a device controller adapted to correlate a USB operation in the second clock domain with the first clock domain based on the periodic packet detection circuit detecting the missing periodic packet.

2. The USB device of claim 1, wherein the missing periodic packet comprises a Start-Of-Frame (SOF) packet.

3. The USB device of claim 1, wherein the signals received in the first clock domain comprises USB 2.0 Transceiver Macrocell Interface (UTMI) or UTMI+ Low Pin Interface (ULPI) signaling.

4. The USB device of claim 3, wherein the periodic packet detection circuit is adapted to decode packet identification in the signals received in the first clock domain to detect the missing periodic packet;
further comprising:
a USB controller separate from the periodic packet detection circuit, the USB controller being adapted to decode packet identification in the signals received in the first clock domain.

5. The USB device of claim 3, wherein the device controller is adapted to determine a feedback to the USB host to adjust a transmission data rate, based on the periodic packet detection circuit detecting the missing periodic packet, to correlate the USB operation in the second clock domain with the first clock domain.

6. The USB device of claim 1, wherein the periodic packet detection circuit is adapted to generate a recovered periodic packet signaling.

7. The USB device of claim 6, wherein the device controller is adapted to determine a feedback to the USB host to adjust a transmission data rate, based on the recovered periodic packet signaling, to correlate the USB operation in the second clock domain with the first clock domain.

8. A method for operating a USB device, comprising:
providing signals in a first clock domain, the signals being received from a USB host;
detecting a missing periodic packet from the signals received in the first clock domain; and
correlating a USB operation in a second clock domain with the first clock domain based on detecting the missing periodic packet.

9. The method of claim 8, wherein the missing periodic packet comprises a Start-Of-Frame (SOF) packet.

10. The method of claim 8, wherein the signals received in the first clock domain comprises USB 2.0 Transceiver Macrocell Interface (UTMI) signaling or UTMI+Low Pin Interface (ULPI).

11. The method of claim 10, wherein detecting the missing periodic packet comprises decoding packet identification in the signals received in the first clock domain;
further comprising:
decoding second packet identification in the signals received in the first clock domain independent of detecting the missing periodic packet.

12. The method of claim 10, wherein correlating the USB operation in the second clock domain with the first clock domain comprises determining a feedback to the USB host to adjust a transmission data rate.

13. The method of claim 8, further comprising generating a recovered periodic packet signaling.

14. The method of claim 13, wherein correlating the USB operation in the second clock domain with the first clock domain comprises determining a feedback to the USB host to adjust a transmission data rate, based on the recovered periodic packet signaling.

15. A USB device, comprising:
at least one signal line adapted to carry UTMI or ULPI signaling;
a USB controller adapted to decode packet identification in the UTMI or ULPI signaling; and
a periodic packet detection circuit, separate from the USB controller, adapted to decode packet identification in the UTMI or ULPI signaling.

16. The USB device of claim 15, wherein the periodic packet detection circuit is adapted to detect a missing periodic packet from the decoded packet identification.

17. The USB device of claim 16, wherein the missing periodic packet is an SOF packet.

18. The USB device of claim 16, wherein the UTMI signaling is in a first clock domain;
further comprising:
a clock operating a second clock domain.

19. The USB device of claim 18, further comprising:
a device controller adapted to correlate a USB operation in the second clock domain with the first clock domain based on the periodic packet detection circuit detecting the missing periodic packet.

20. The USB device of claim 19, wherein the device controller is adapted to determine a feedback to a USB host to adjust a transmission data rate, based on the periodic packet detection circuit detecting the missing periodic packet, to correlate the USB operation in the second clock domain with the first clock domain.

21. The USB device of claim 15, wherein the periodic packet detection circuit is adapted to generate a recovered periodic packet signaling.

22. The USB device of claim 21, wherein the UTMI or ULPI signaling is in a first clock domain;
further comprising:
a device controller adapted to determine a feedback to a USB host to adjust a transmission data rate, based on the recovered periodic packet signaling, to correlate a USB operation in a second clock domain with the first clock domain.

23. A method for operating a USB device, comprising:
decoding packet identification in UTMI or ULPI signaling via a first decoding path; and
decoding second packet identification in the UTMI or ULPI signaling via a second decoding path, the second decoding path being independent from the first decoding path.

24. The method of claim 23, further comprising detecting a missing periodic packet from the decoded packet identification.

25. The method of claim 24, wherein the missing periodic packet is an SOF packet.

26. The method of claim 24, wherein the UTMI signaling is in a first clock domain;
further comprising:
operating a USB operation in a second clock domain.

27. The method of claim 26, further comprising:
correlating the USB operation in the second clock domain with the first clock domain based on detecting the missing periodic packet.

28. The method of claim 27, wherein correlating the USB operation in the second clock domain with the first clock domain comprises determining a feedback to a USB host to adjust a transmission data rate, based detecting the missing periodic packet.

29. The method of claim 23, further comprising generating a recovered periodic packet signaling.

30. The method of claim 29, wherein the UTMI or ULPI signaling is in a first clock domain;
Further comprising:
correlating a USB operation in a second clock domain with the first clock domain comprises determining a feedback to a USB host to adjust a transmission data rate, based on the recovered periodic packet signaling.
